(19) United States
(12) Patent Application Publication
(10) Pub. No.: US 2007/0012682 A1
(43) Pub. Date: Jan. 18, 2007

(54) Rare earth element contained substrate for heat generating device

(76) Inventor: Cheng Ping Lin, Taipei (TW)

Correspondence Address: BRUCE H. TROXELL, SUITE 1404, 5205 LEESBURG PIKE, FALLS CHURCH, VA, 22041, US

(21) Appl. No.: 11/180,515

(22) Filed: Jul. 14, 2005

(51) Int. Cl. H05B 3/10

(52) U.S. Cl. 219/548; 219/546

(57) ABSTRACT

A rare earth element contained substrate for heat generating device contains the rare earth elements, compounds of rare earth elements, or rare earth minerals so as to heighten its withstanding temperature and improve its heat dissipation, and it is also able to radiate a for infrared ray and yield negative ions for purifying the air.

### BACKGROUND OF THE INVENTION

1. Field of the Invention

The present invention relates to a rare earth element contained substrate, for generating device, and more particularly, to a substrate for the neat generating device, where the substrate contains the rare earth elements, compounds of rare earth elements, or rare earth on minerals so as to heighten its withstanding temperature and improve its heat dissipation, and it is able to radiate a far infrared ray and yield negative tons for purifying the air.

2. Description of the Prior Art

As it is well known, a conventional electrical heating device is usually made of a metallic wire, metallic bar, or metallic plate with substantially high resistance; sometime it is formed into a tubular heat generating device containing an electrical heater wire in it.

No matter what the heat generating element is made of a metallic wire (electrical heater wire) a metallic bar (electrical heater bar), a metallic plate (electrical heater plate), or an electrical heater tube, it has the fallowing noticeable defects:
1. The heat generating device made of the aforesaid elements has several common disadvantages that it radiates a harmful electromagnetic wave, and produces useless light energy loss when carrying a current.
2. Being made of resistant material the a foresaid elements generate available heat when carrying a current However, it is problematic as to haw to precisely estimate the obtainable heat energy from a given element of a predeterminded size such as length and cross section because all of the aforesaid heat generating elements have indefinite properties difficult to figure out.
3. With the unsolved problems discussed above, the conventional electrical heating devices are definitely not qualified for use in present day high technical electronic industry.

For improving the noticeable defends on the prior art, the inventor has dedicated great efforts for years and has applied patents for invention or new models to intelligence property office in Taiwan, for example: “Electrical Heater Film” (Taiwan Pat. App. No. 93114226) “Electrical Heater Film as Heating Device” (Taiwan Pat. App. No. 93214315), and “Uniform Temperature Heat Conducting Surface Board” (Taiwan Pat. App. No. 93215909).

In the above mentioned electrical heating devices the electrical heater film is made of semiconductor material and is fabricated according to the fabrication process of a semiconductor device. In order to avoid degrading the heat production efficiency, occurrence of an electric shock or radiation of harmful electromagnetic wave when carrying a current, the inventor has provided a ceramic substrate. Notwithstanding its excellent heat energy preservation effect, the ceramic substrate is fragile and frangible, and from a certain angle of view, it is noticeable for poor heat dissipation. The continuation of the research in this respect has finally brought up the inventor to come up with the present invention.

### SUMMARY OF THE INVENTION

Accordingly, the main object of the present invention is to provide a heat generating device which can radiate far infrared ray good for health of the human body and yield negative ions for air purification.

The another object of the present invention is to provide a heat generating device whose strength of ceramic substrate can be enhanced to resist extraneous breaking force and assist to improve heat generating efficiency and heat dissipation effect.

To achieve the above objects, the heat generating device of the present invention uses rare earth element contained ceramic substrate, the rare earth elements come from adding material containing rare earth elements, their chemical compounds or minerals. The substrate is formed into various shapes such as a flat plate [symbol] tubular or porous state.

For further understanding of the nature and objects of the invention, reference should be made to the fallowing detailed description taken in conjunction with the accompanying drawings showings below.

### BRIEF DESCRIPTION OF THE DRAWINGS

FIGS. 1 [symbol] 2 [symbol] 3a and 3b show respectively first to forth examples of the invention.

### DETAILED DESCRIPTION OF THE PREFERRED EMBODIMENTS

In the present invention, the substrate of the heat generating device is made of high temperature with standing material containing the rare earth elements which are extracted from the mineral ores containing the rare earth elements.

In present-day, there are more than ten rare earth elements discovered existing in the earth namely! Th [symbol] Ce [symbol] La [symbol] Pr [symbol] Nd [symbol] Sm [symbol] Eu [symbol] Gd [symbol] Yt [symbol] Dy [symbol] Ho [symbol] Be [symbol] Er [symbol] Lu [symbol] Sc [symbol] Ta [symbol] Tu etc. They can be extracted from the minerals are containing the same such as arthite, and others are Ce—Si ore [symbol] P—Ce—La ore [symbol] Si—Be—Gd ore [symbol] Yt-Ta Ore and phosphate ore. The substrate contains the family of the rare earth elements in the form elements, compounds, or ores.

The ceramic substrate made of violet celestite has a high melting point as high as 1400° c., and its mechanical strength increases in proportion to the temperature up to 1200° c. so as to contribute to enhancing the stability of the heat generating device. Adding the rare earth elements into the substrate makes the heat generating device to have an excellent heat generating efficiency and better heat dissipation performance accompanying with a mechanically strong substrate. Moreover, his radiation of a far infrared ray and yielding negative ions when been heated contributes to functioning remote heating and purification of air.

### EXAMPLE 1

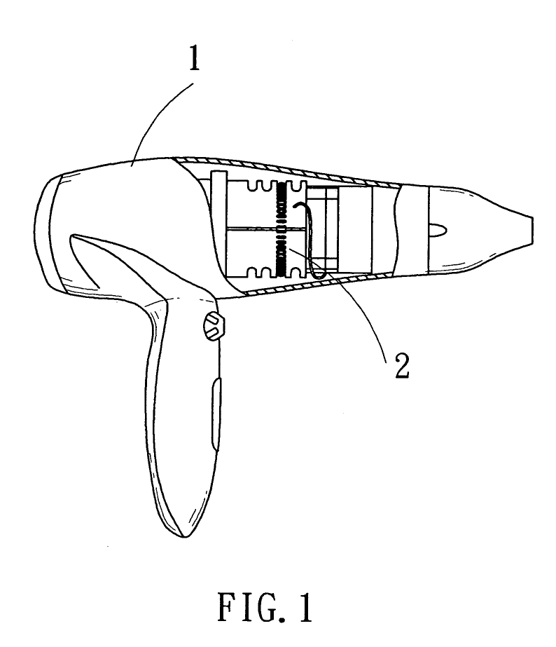

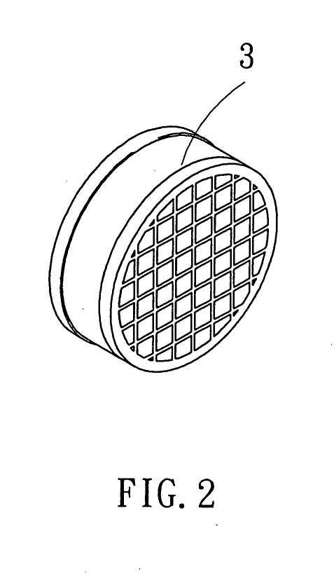

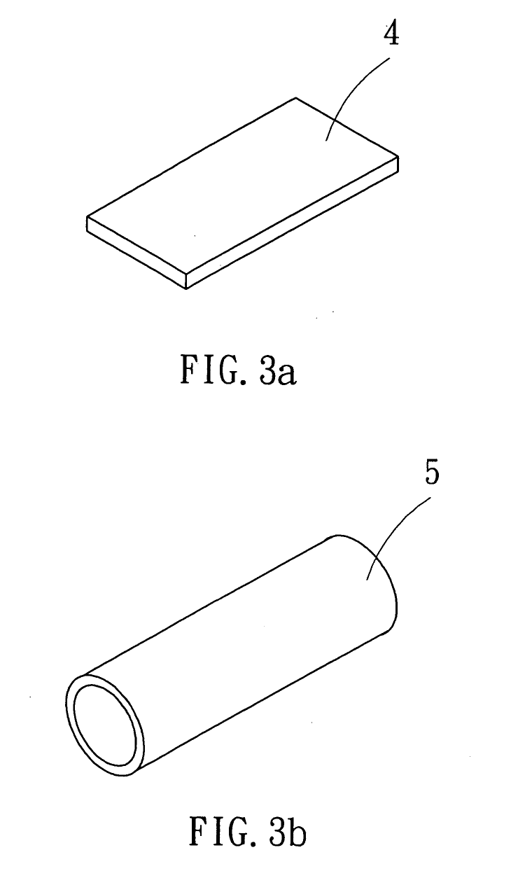

As shown in FIG. 1, the rare earth element contained substrate of the heat generating device according to the present invention is formed into a multi-layered substrate 2 accommodated in a hair dryer 1. When being heated, the far infrared ray radiated from, and the negative ions produced, serve to quickly dry the hair and protect the hairs in harmless condition.

### EXAMPLE 2

As shown in FIG. 2, the rare earth element contained substrate of the present invention is incorporated with a cellular ceramic heat generating device 3. By so, the porous ness of the heat generating device 3 assists the substrate to fully make use of its feature of the rare earth element material to upgrade the heat generation and radiation of a far infrared ray effects.

### EXAMPLE 3

As shown in FIGS. 3a and 3b, the rare earth element contained substrate may be formed into various shapes of a flat plate 4, a circular tube 5, or others.

In all the heat generating device of the present invention has several noteworthy features attributed to its rare earth element contained substrate. The rare earth elements contained in the substrate not only serves to improve the mechanical strength of the substrate itself, but also contribute, to promote heat generation far infrared ray radiation, and yielding negative ions by the heat generating device.

It is understood that the present invention is a high level technical creation and by no means, simply utilizes conventional technology, or knowledge known prior to the application for patent, or can easily made by persons skilled in the arts. Prior to this application for patent, the invention has never been published, therefore present invention is entitled for applying patent.

Those who are skilled in the art will readily perceive how to modify the invention. Therefore the appended claims are to be construed to cover all equivalent structures which fall within the true scope and spirit of the invention.

What is claimed is:

1. A rare earth element contained substrate for heat generating device wherein said substrate being made of a high temperature withstanding material containing the rare earth element material.

2. The substrate as claimed in claim 1, wherein said rare earth element material is the rare earth elements, the compound of rare earth elements, or the rare earth element minerals.

3. The substrate as claimed in claim 1, wherein said substrate is configurated into a flat plate, or a circular tube.

4. The substrate as claimed in claim 2, wherein said substrate is configurated into a flat plate, or a circular tube.
